(19) United States
(12) Patent Application Publication
(10) Pub. No.: US 2026/0040074 A1
(43) Pub. Date: Feb. 5, 2026

(54) NETWORK NODE, USER EQUIPMENT AND METHODS PERFORMED THEREIN

(71) Applicant: Telefonaktiebolaget LM Ericsson (publ), Stockholm (SE)

(72) Inventors: Sasa DOLENC, Samobor (HR); Mats BRUNNBERG, Linkoping (SE)

(21) Appl. No.: 19/100,016

(22) PCT Filed: Aug. 2, 2023
(86) PCT No.: PCT/EP2023/071432

§ 371 Date: Jan. 30, 2025

Related U.S. Application Data
(60) Provisional application No. 63/370,498, filed on Aug. 5, 2022.

(51) Int. Cl. H04W 12/08; H04L 43/0876; H04W 28/02

(52) U.S. Cl. CPC H04W 12/08; H04L 43/0876; H04W 28/0284

(57) ABSTRACT

Embodiments herein may comprise a method performed by a network node (12) for handling access of a UE (10) in a communication network. The network node (12) receives a request for accessing the network node or a cell related to the network node, wherein the request comprises an indication indicating privileged access even if the network node, the cell and/or hardware of the network node is congested. The network node further determines, when the network node, the cell and/or the hardware of the network node is congested, to accept the request from the UE taking the indication into account.

### TECHNICAL FIELD

Embodiments herein relate to a network node, a user equipment (UE) and methods performed therein regarding communication. Furthermore, a computer program product and a computer-readable storage medium are also provided herein. In particular, embodiments herein relate to handling communication, such as handling or controlling access of the UE, in a communication network.

### BACKGROUND

In a typical communication network, UEs, also known as wireless communication devices, mobile stations, stations (STA) and/or wireless devices, servers, computers, communicate via an Access Network (AN), such as a radio access network (RAN) or a wired access network, with one or more core networks (CNs). The AN covers a geographical area which is divided into service areas or cells, with each service area or cell being served by a network node such as an access node e.g. a Wi-Fi access point or a radio base station (RBS), which in some networks may also be called, for example, a NodeB, a gNodeB (gNB), or an eNodeB (eNB). The service area or cell is a geographical area where radio coverage is provided by the network node. The network node operates on radio frequencies to communicate over an air interface with the UEs within range of the access node. The network node communicates over a downlink (DL) to the UE and the UE communicates over an uplink (UL) to the access node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate, e.g., enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises, and coordinates various activities of the plural radio network nodes connected thereto. The RNCs are typically connected to one or more core networks.

Specifications for the Evolved Packet System (EPS) have been completed within the 3GPP and present and coming 3GPP releases, such as New Radio (NR) and extensions, are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially “flat” architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

3GPP is currently working on Release (Rel) 17 enhancements to first specifications of the 5G system of Rel 15 and/or 16. These types of enhancements are made to functionality that was introduced in early releases of the 5G specification.

National Security and Public Safety (NSPS) communications require a reliable, highly secure, interoperable, and innovative communication platform. Public safety agencies and first responders need to get information more quickly to help them make faster and better decisions. Using LTE for Public Safety created a demand for solutions that will prioritize network access for public safety users and first responders. In USA the First Responder Network Authority, or the FirstNet Authority, is an independent agency within the U.S. Department of Commerce's National Telecommunications and Information Administration (NTIA) that oversees FirstNet, the nation's communication network dedicated to emergency responders and the public safety community. The eNB must have implemented solutions that will prioritize network access for public safety users and first responders on both Uu interface and internal resources, such as UE context, Radio Bearers. The eNB internal resources or capacity limitations on eNB, hardware (HW), and Cell level must not be reached without previous attempts to prioritize public safety users and first responders, and to preempt preemptible (commercial) users.

### SUMMARY

As part of developing embodiments herein, one or more problems were first identified. When a network node internal capacity limitation is reached, the system will reject a new UE context admission request, and the requesting UE will be released. In case of congestion where any internal network node capacity limitation is about to be reached, it is mandatory that NSPS users are given admission priority. An object herein is to provide a mechanism to handle communication efficiently for privileged UEs in the communication network.

According to an aspect the object is achieved, according to embodiments herein, by providing a method performed by a network node for handling access of a UE in a communication network. The network node receives, from the UE, a request for accessing the network node or a cell related to the network node. The request comprises an indication indicating privileged access (PA) even if the network node, the cell and/or hardware of the network node is congested. The network node, when the network node, the cell and/or the hardware of the network node is congested, determines to accept the request from the UE taking the indication into account.

According to yet another aspect the object is achieved, according to embodiments herein, by providing a method performed by a UE for handling access of the UE in a communication network. The UE transmits to a network node, a request for accessing the network node or a cell related to the network node. The request comprises an indication indicating privileged access even if the network node, the cell and/or hardware of the network node is congested. The UE receives from the network node, a response accepting the request.

According to yet another aspect the object is achieved, according to embodiments herein, by providing a network node for handling access of a UE in a communication network. The network node is configured to receive, from the UE, a request for accessing the network node or a cell related to the network node. The request comprises an indication indicating privileged access even if the network node, the cell and/or hardware of the network node is congested. The network node is further configured to determine, when the network node, the cell and/or the hardware of the network node is congested, to accept the request from the UE taking the indication into account.

According to yet another aspect the object is achieved, according to embodiments herein, by providing a UE for handling access of the UE in a communication network. The UE is configured to transmit to a network node, a request for accessing the network node or a cell related to the network node. The request comprises an indication indicating privileged access even if the network node, the cell and/or hardware of the network node is congested. The UE is configured to receive from the network node, a response accepting the request.

It is furthermore provided herein a computer program product comprising instructions, which, when executed on at least one processor, cause the at least one processor to carry out the methods herein, as performed by the network node and the UE, respectively. It is additionally provided herein a computer-readable storage medium, having stored thereon a computer program product comprising instructions which, when executed on at least one processor, cause the at least one processor to carry out the methods herein, as performed by the network node and the UE, respectively.

Embodiments herein disclose ways to, in case of congestion where, for example, UE context capacity limitation on Cell, HW, and/or network node may be reached, a part of UE context resources may be reserved for privileged UEs, for example, PA UEs.

UE resource request to be considered to have PA and allowed to use reserved resources:
RRC Connection Request with establishmentCause=highPrioriyAccess (HPA)
RRC Connection Request with establishementCause=emergency (EC)

Operator configurable Cell, HW, eNB PA pools.

For every UE context admission in at least one PA pool, e.g., Cell, HW, and/or eNB level, the system may start a UE preemption process.

In a congestion situation where UE context resources on, e.g., a Cell, HW, and/or eNB level, are about to be exhausted, the system may reserve a share of UE context resources for PA UEs, e.g., HPA UEs and EC UEs.

On every UE context allocation in PA pool on any level, the system may start a preemption process.

Regardless of preemption result, requesting UE, such as an HPA UE or an EC UE, will stay admitted in PA pool.

Thus, embodiments herein handle communication efficiently for PA UEs in the communication network.

### BRIEF DESCRIPTION OF THE DRAWINGS

Embodiments will now be described in more detail in relation to the enclosed drawings, in which:

FIG. 1 shows a communication network according to embodiments herein;

FIG. 2 shows a combined signalling scheme and flowchart according to embodiments herein;

FIG. 3 shows a flowchart depicting a method performed by a network node according to embodiments herein;

FIG. 4 shows a flowchart depicting a method performed by a UE according to embodiments herein;

FIG. 5 shows a schematic overview of different levels according to some embodiments herein;

FIG. 6 shows a combined flowchart and signalling scheme according to some embodiments herein;

FIGS. 7a-7b show schematic overviews depicting a network node according to embodiments herein;

FIGS. 8a-8b show schematic overviews depicting a UE according to embodiments herein;

FIG. 9 schematically illustrates a telecommunication network connected via an intermediate network to a host computer;

FIG. 10 is a generalized block diagram of a host computer communicating via a base station with a user equipment over a partially wireless connection; and

FIGS. 11, 12, 13 and 14 are flowcharts illustrating methods implemented in a communication system including a host computer, a base station and a user equipment.

### DETAILED DESCRIPTION

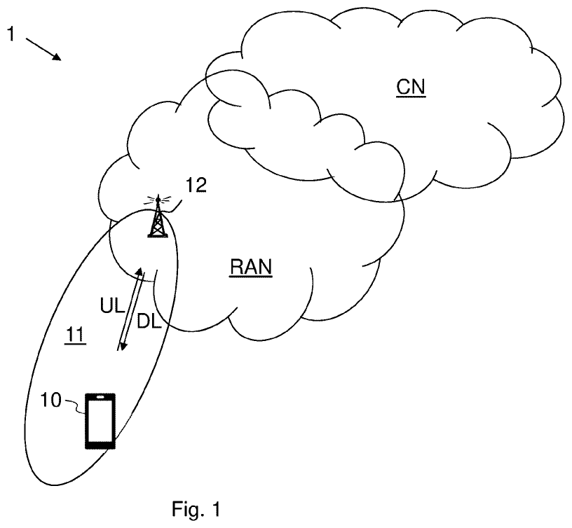

Embodiments herein relate to communication networks in general. FIG. 1 is a schematic overview depicting a communication network 1. The communication network 1 comprises one or more access networks, such as RANs or wired access networks, and one or more CNs. The communication network 1 may use one or a number of different technologies. Embodiments herein relate to recent wired and wireless networks such as Wi-Fi, new radio (NR), other existing wired or wireless networks, and further developments of existing wireless communications systems such as e.g., LTE or WCDMA.

In the communication network 1, a UE 10, for example, a wireless device such as a mobile station, a non-access point (non-AP) station (STA), a STA and/or a wireless terminal, is comprised communicating via the one or more Access Networks (AN) to other UEs or one or more CNs. It should be understood by the skilled in the art that “UE” is a non-limiting term which means any terminal, wireless communications terminal, internet of things (IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node. The UE 10 may be a requesting Privileged Access (PA) UE such as a High Priority Access (HPA) UE or an Emergency (EC) UE.

The communication network 1 comprises a network node 12 providing radio coverage over a geographical area, a first service area 11 or first cell, of a first RAT, such as WiFi, NR, LTE, or similar. The network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a UE within the area served by the radio network node depending e.g. on the first radio access technology and terminology used. The network node 12 may be an access node such as a WiFi-modem or a radio network node and may be referred to as a serving radio network node wherein the service area may be referred to as a serving cell. It should be noted that a service area may be denoted as cell, beam, beam group or similar to define an area of radio coverage.

According to some embodiments herein in case of congestion the UE indicating PA is accepted to access the communication network.

According to some embodiments herein in case of congestion, where use of UE resources such as eNB UE context resource limitation is about to be reached, a reservation, may be provided, of a part of UE context system resources for PA on network node, HW, and/or cell level, and may further trigger a respective preventive preemption process. No matter of preemption result, a requesting PA UE will stay admitted. In case that UE preemption was unsuccessful in the cell where requesting UE request UE context resource, the system will search for preemptible UE on Cell, HW, network node level, and may trigger UE preemption in the selected cell, and if candidate cell is not found, the requesting UE 10 will stay admitted without triggering UE preemption.

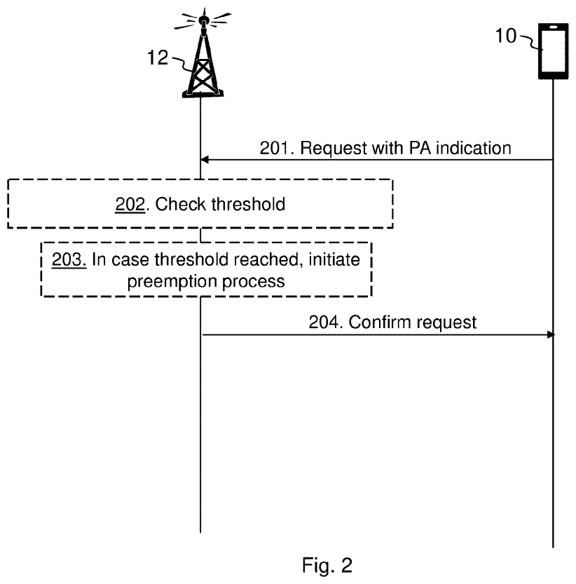

FIG. 2 is a combined signalling and flowchart scheme according to some embodiments herein focusing on the estimated signal quality.

Action 201. The UE 10 transmits a request for accessing the network node 12 or a cell related to the network node 12. The request comprises an indication indicating PA even if the network node, the cell and/or hardware of the network node is congested. The indication may comprise a flag or a value indicating PA.

Action 202. The network node 12 may check current load with a capability threshold at the network node 12. The capability threshold may indicate a congestion at the network node 12.

Action 203. In case the current load related to the network node 12 has reached the capability threshold or is within a range of the capability threshold, the network node 12 may initiate a preemption process related to UE context resources of the network node, the cell and/or the hardware of the network node.

Action 204. The network node 12 determines even if the network node, the cell and/or hardware of the network node is congested, to accept the request from the UE based on the indication. I.e., the UE 10 is allowed to access the network node 12 or the cell related to the network node 12.

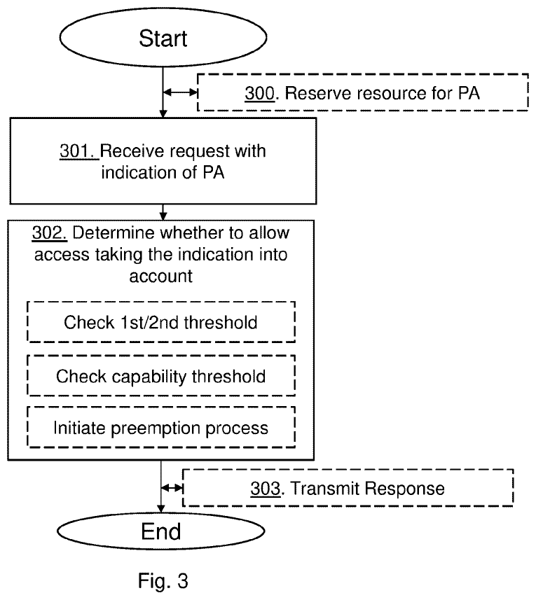

The method actions performed by the network node 12 for handling access of the UE 10 in the communication network 1 according to embodiments herein will now be described with reference to a flowchart depicted in FIG. 3. The actions do not have to be taken in the order stated below, but may be taken in any suitable order. Dashed boxes indicate optional features.

Action 300. The network node 12 may reserve a part of UE context system resources for PA on a network node, HW, and/or cell level.

Action 301. The network node 12 receives the request, for example, an access request, for accessing the network node 12 or a cell related to the network node 12. The request comprises the indication indicating PA even if the network node 12, the cell and/or the hardware of the network node 12 is congested. The indication may comprise a flag or a value indicating PA.

Action 302. The network node 12 determines, when the network node, the cell and/or the hardware of the network node is congested, to accept the request from the UE taking the indication into account (or based on the indication).

The network node 12 may check current load with a first and/or second preemption threshold at the network node 12. The first and/or second preemption threshold may indicate a congestion on network node and/or a HW level. The first preemption threshold may comprise an eNB preemption threshold, and/or the second preemption threshold may comprise a cell preemption threshold.

The network node 12 may additionally or alternatively, check current load with a capability threshold at the network node 12.

In case the current load related to the network node 12 has reached the capability threshold and/or the first and/or second preemption threshold, or is within a range of the capability threshold and/or the first and/or the second preemption threshold, the network node 12 may initiate a preemption process related to UE context resources. The radio network node may trigger, when the network node 12, and/or the hardware of the network node 12 is congested, a preemption process in a different cell than an originating cell where the UE 10 requested access.

Action 303. The network node 12 may then transmit a response to the UE 10 indicating acceptance of the request.

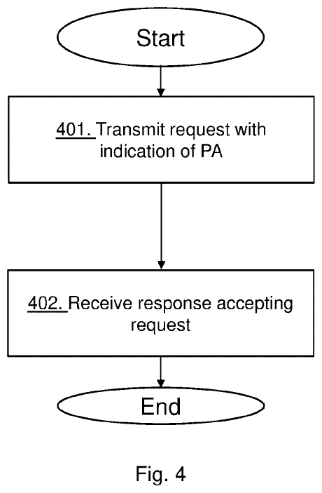

The method actions performed by the UE 10 for handling access of the UE 10 in the communication network 1 according to embodiments herein will now be described with reference to a flowchart depicted in FIG. 4. The actions do not have to be taken in the order stated below but may be taken in any suitable order. Dashed boxes indicate optional features.

Action 401. The UE 10 transmits to the network node 12, the request for accessing the network node 12 or the cell related to the network node 12. The request comprises the indication indicating PA even if the network node 12, the cell and/or the hardware of the network node 12 is congested. The indication may comprise a flag or a value indicating PA. The indication may comprise an establishment-cause value in an RRC connection message. For example, the indication may comprise an establishmentCause=highPrioriyAccess (HPA) in an RRC Connection Request, or an establishementCause=emergency (EC) in an RRC Connection Request.

Action 402. The UE 10 receives from the network node 12, a response accepting the request.

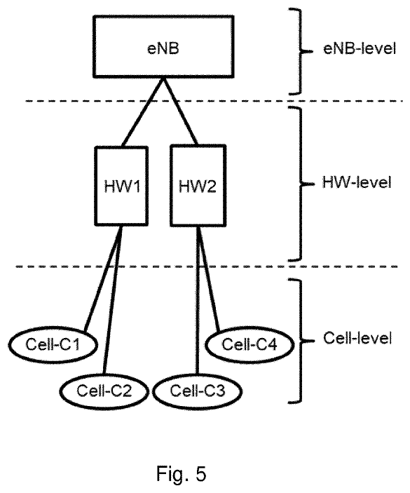

FIG. 5 discloses schematically some embodiments herein.

The UE 10 (or PA UE) requests admission of UE context in Cell-C1.

Example 1: Cell-C1 is in congestion (Cell-C1 UE context PA pool threshold is reached), and the UE 10 is admitted to Cell-C1 PA pool. The system starts a preemption process in Cell-C1, and regardless of preemption result the requesting UE 10 is admitted to Cell-C1.

Example 2: HW1 is in congestion (HW1 UE context PA pool threshold is reached), and PA UE is admitted to HW1 UE context PA pool. The system starts preemption process in Cell-C1, and if preemption is unsuccessful the system searches all active cells on HW 1 that are marked as preemption candidates. If cell-C2 is selected as a preemption candidate, the system starts preemption process in Cell-C2. The requesting UE 10 is then admitted to Cell-C1.

Example 3. The network node 12, e.g., a eNB, is in congestion (eNB UE context PA pool threshold is reached), and the UE 10 is admitted to the eNB UE context PA pool. The system starts a preemption process in Cell-C1, and if preemption is unsuccessful the system searches all active cells on HW1 and HW2 that are marked as preemption candidates. If Cell-C4 is selected as a preemption candidate, the system starts preemption process in Cell-C4. The requesting UE 10 is then admitted to the Cell-C1.

FIG. 6 is a combined flowchart and signalling scheme according to some embodiments herein between the network node 12 and the UE 10.

For every UE context admission request, the system will check, action 601, if the eNB preemption threshold (operator defined) is reached:

If the eNB preemption threshold is reached, the system will check, action 602, if the node UE context capacity limitation has been reached:
If the eNB UE context capacity limitation is reached, the requesting UE is rejected.
If the eNB UE context capacity limitation is not reached, the requesting UE is checked, action 603, for PA:
   If requesting UE is PA, the system will flag, action 604, the UE with eNB preemption flag.
   If requesting UE is not PA, the requesting UE is rejected.

If the eNB preemption threshold is not reached, or if the eNB preemption flag is set, the system will continue to check, action 605, if the Cell preemption threshold (operator defined) is reached:
If the Cell preemption threshold is reached, the system will check, action 606, if the cell UE context capacity limitation has been reached:
   If the Cell UE context capacity limitation is reached, the requesting UE is rejected.
      If the Cell UE context capacity limitation is not reached, the requesting UE is checked, action 607, for PA:
         If requesting UE is PA, the system will flag, action 608, the UE with Cell preemption flag.
         If requesting UE is not PA, the requesting UE is rejected.
   If the Cell preemption threshold is not reached, or if the Cell preemption flag is set, the system will send, action 609, UE allocation request to HW:
      If the HW answer, action 610, is “Reject”, the requesting UE is rejected
      If the HW answer, action 610, is “Accept with flag”, the system will check, action 611, requesting UE for PA:
         If requesting UE is PA, the system will flag, action 612, the UE with HW preemption flag.
         If requesting UE is not PA, the requesting UE is rejected.
      If the HW answer, action 610, is “Accept” the system will continue to next step.
      If the HW answer, action 610, is “Accept” or if HW preemption flag is set, the system will check, action 613, if any flag is set:
         If no flags are set, the system will admit requesting UE.
         If any flag is set, the system will confirm, action 614, if requesting UE is PA after S1: Initial Context Setup from MME.
         If requesting UE is not confirmed for PA, the requesting UE is rejected.
         If requesting UE is confirmed for PA, the system will continue to next step.
   *The system will check, action 615, if requesting UE have authority for preemption (Preemption Capability Indicator (PCI)=1):
      If the requesting UE does not have authority for preemption (PCI=0) the requesting UE is admitted.
      If the requesting UE have authority for preemption (PCI=1) the system will start, action 616, preemption process:
         Action 617, if the preemption is successful, the requesting UE is admitted.
         If the preemption is unsuccessful, the system will check, action 618, for type of flag:
         If type of flag is Cell, the requesting UE is admitted.
         If the type of flag is HW or HW and cell, the system will search, action 619, for all active cells on that HW that are marked as preemption candidates:
         Action 620, if the system selects a candidate cell, it will start, action 621, preemption process in that cell, and requesting UE is admitted.
         If the system did not select a candidate cell, the requesting UE is admitted.
         If the tape of flag is eNB or eNB and HW or eNB and Cell or eNB and HW and Cell, the system will search, action 619, for all active cells on all HW that are marked as preemption candidates:
         Action 620, if the system selects a candidate cell, it will start, action 621, preemption process in that cell, and requesting UE is admitted.
         If the system did not select a candidate cell, the requesting UE is admitted.

*Note: If operator choose to create any HPA user profile(s) without preemption authority (PCI=0) and without authority to be preempted (Preemption Vulnerability Indicator (PVI)=0), then those users may fill up reserved PA UE context pool(s) and bring the system to maximum UE context capacity state. It is strongly advised that HPA and/or EC UE with PCI=0 PVI=0 is not configured.

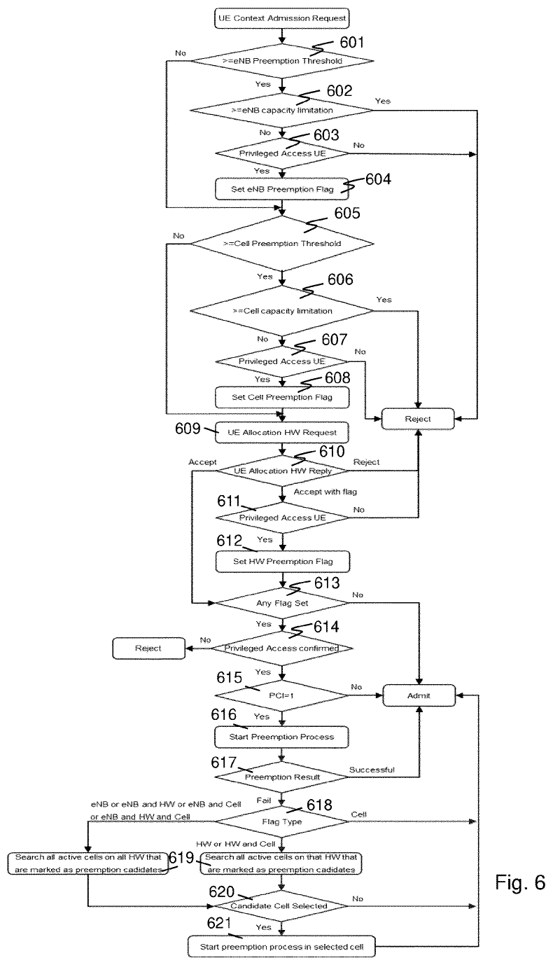

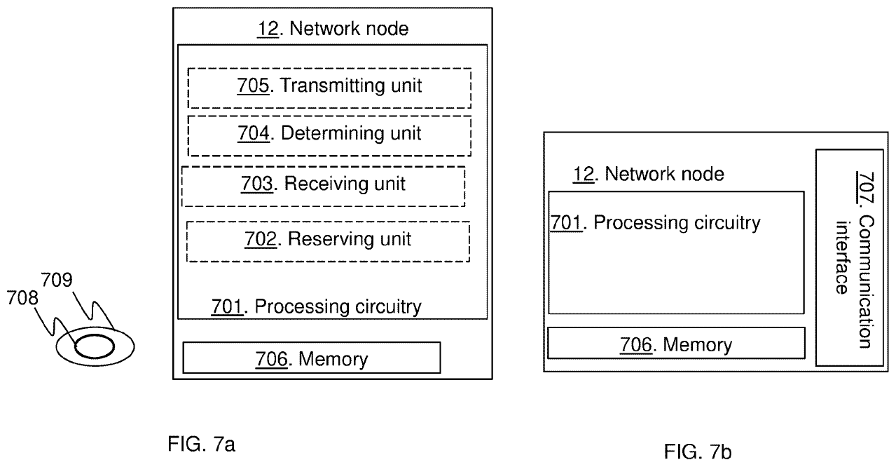

FIGS. 7a-b are schematic overviews of the network node 12 for handling access of the UE 10 in the communication network 1 according to embodiments herein.

The network node 12 may comprise processing circuitry 701, e.g., one or more processors, configured to perform the methods herein.

The network node 12 may comprise a reserving unit 702. The network node 12, the processing circuitry 701 and/or the reserving unit 702 may be configured to reserve a part of UE context system resources for PA on a network node, HW, and/or cell level.

The network node 12 may comprise a receiving unit 703, such as a receiver and/or transceiver. The network node 12, the processing circuitry 701 and/or the receiving unit 703 is configured to receive the request, for example, an access request, for accessing the network node 12 or a cell related to the network node 12. The request comprises the indication indicating PA even if the network node, the cell and/or hardware of the network node is congested. The indication may comprise a flag or a value indicating PA.

The network node 12 may comprise a determining unit 704. The network node 12, the processing circuitry 701 and/or the determining unit 704 is configured to determine, when the network node, the cell and/or the hardware of the network node is congested, to accept the request from the UE taking the indication into account (or based on the indication). The network node 12, the processing circuitry 701 and/or the determining unit 704 may be configured to check current load with the first and/or second preemption threshold at the network node 12. The network node 12, the processing circuitry 701 and/or the determining unit 704 may additionally or alternatively be configured to check current load with the capability threshold at the network node 12. In case the current load related to the network node 12 has reached the capability threshold and/or the first and/or second preemption threshold, or is within a range of the capability threshold and/or the first and/or the second preemption threshold, the network node 12, the processing circuitry 701 and/or the determining unit 704 may be configured to initiate a preemption process related to UE context resources.

The network node 12 may comprise a transmitting unit 705, such as a transmitter and/or transceiver. The network node 12, the processing circuitry 701 and/or the transmitting unit 705 may be configured to transmit the response to the UE 10 indicating acceptance of the request.

The network node 12 may comprise a memory 706. The memory 706 comprises one or more units to be used to store data on, such as data packets, grants, parameter(s), indices, configuration, indications, flags, thresholds, measurements, events and applications to perform the methods disclosed herein when being executed, and similar. Furthermore, the network node 12 may comprise a communication interface 707, see FIG. 7b, comprising such as a transmitter, a receiver, a transceiver and/or one or more antennas.

The methods according to the embodiments described herein for the network node 12 are respectively implemented by means of e.g. a computer program product 708 or a computer program, see FIG. 7a, comprising instructions, i.e., software code portions, which, when executed on at least one processor, cause the at least one processor to carry out the actions described herein, as performed by the network node 12. The computer program product 708 may be stored on a computer-readable storage medium 709, see FIG. 7a, e.g. a disc, a universal serial bus (USB) stick or similar. The computer-readable storage medium 709, having stored thereon the computer program product, may comprise the instructions which, when executed on at least one processor, cause the at least one processor to carry out the actions described herein, as performed by the network node 12. In some embodiments, the computer-readable storage medium may be a transitory or a non-transitory computer-readable storage medium. Thus, embodiments herein may disclose a network node for handling access of a UE in the communication network, wherein the network node 12 comprises processing circuitry and a memory, said memory comprising instructions executable by said processing circuitry whereby said network node is operative to perform any of the methods herein.

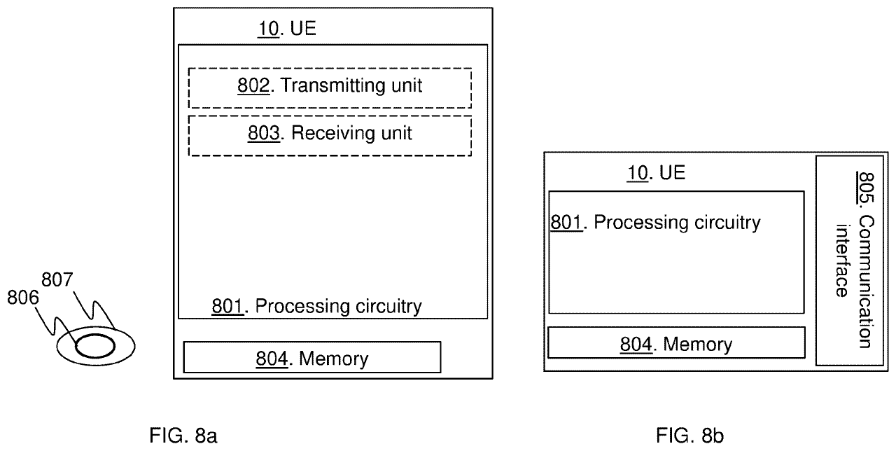

FIGS. 8a-b are schematic overviews of the UE 10 for handling access of the UE 10 in the communication network 1 according to embodiments herein.

The UE 10 may comprise processing circuitry 801, e.g. one or more processors, configured to perform the methods herein.

The UE 10 may comprise a transmitting unit 802, e.g., a writer, a transmitter or transceiver. The UE 10, the processing circuitry 801, and/or the transmitting unit 802 is configured to transmit to the network node 12, the request for accessing the network node or the cell related to the network node. The request comprises the indication indicating the PA even if the network node, the cell and/or hardware of the network node is congested. The indication may comprise a flag or a value indicating PA.

The UE 10 may comprise a receiving unit 803, e.g., the receiver, or transceiver. The UE 10, the processing circuitry 801, and/or the receiving unit 803 is configured to receive from the network node 12, a response accepting the request.

The UE 10 may comprise a memory 804. The memory 804 comprises one or more units to be used to store data on, such as data packets, grants, parameter(s), indices, configuration, indications, measurements, events and applications to perform the methods disclosed herein when being executed, and similar. Furthermore, the UE 10 may comprise a communication interface 805, see FIG. 8b, such as comprising a transmitter, a receiver, a transceiver and/or one or more antennas.

The methods according to the embodiments described herein for the UE 10 are respectively implemented by means of e.g. a computer program product 806 or a computer program, see FIG. 8a, comprising instructions, i.e., software code portions, which, when executed on at least one processor, cause the at least one processor to carry out the actions described herein, as performed by the UE 10. The computer program product 806 may be stored on a computer-readable storage medium 807, see FIG. 8a, e.g. a disc, a universal serial bus (USB) stick or similar. The computer-readable storage medium 807, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE 10 for adapting the signal processing capability of the receiver comprised in the UE 10 in the communication network, wherein the UE 10 comprises processing circuitry and a memory, said memory comprising instructions executable by said processing circuitry whereby said UE 10 is operative to perform any of the methods herein.

In some embodiments a more general term “network node” is used and it can correspond to any type of radio-network node or any network node, which communicates with a wireless device, wired device and/or with another network node. Examples of network nodes are, router, modem, server, UE, NodeB, master (M) eNB, secondary(S) eNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), internet of things (IoT) capable device, machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

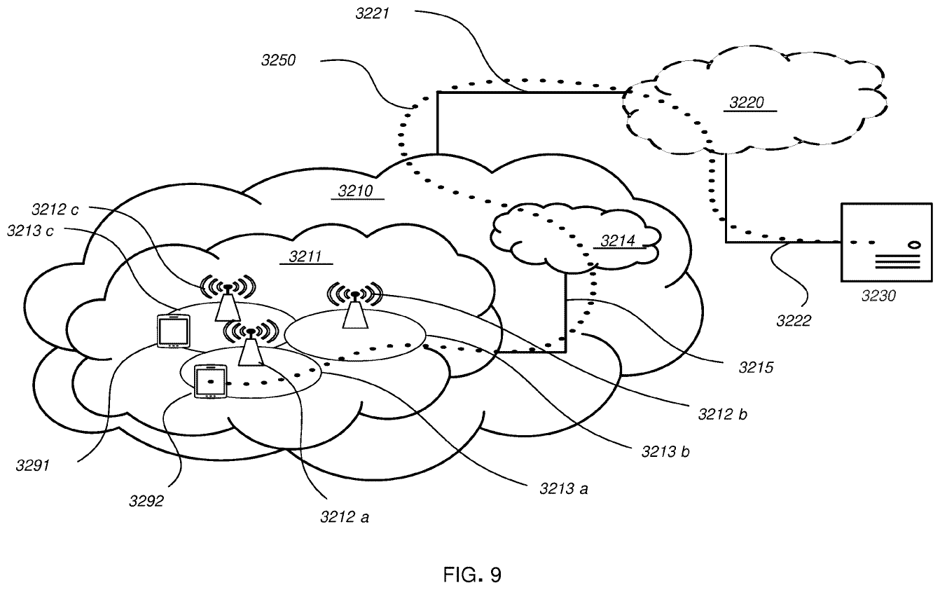

With reference to FIG. 9, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the network node 12 herein, each defining a corresponding coverage area 3213a, 3213b, 3213c. Each base station 3212a, 3212b, 3212c is connectable to the core network 3214 over a wired or wireless connection 3215. A first UE 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

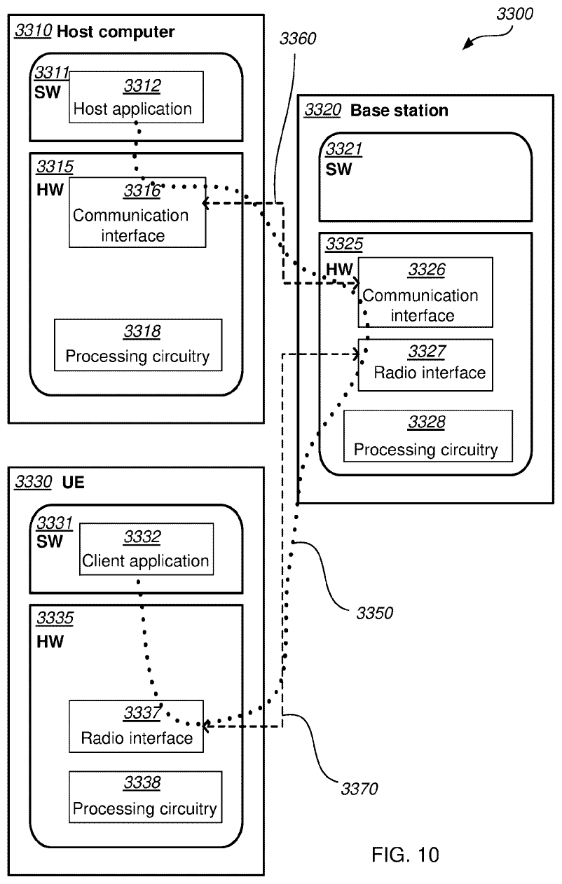

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 17) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 10 may be identical to the host computer 3230, one of the base stations 3212a, 3212b, 3212c and one of the UEs 3291, 3292 of FIG. 9, respectively.

This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing, e.g., on the basis of load balancing consideration or reconfiguration of the network.

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since the PA UEs are admitted and thereby provide benefits such as improved efficiency and may lead to better performance such as responsiveness of the PA UE.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

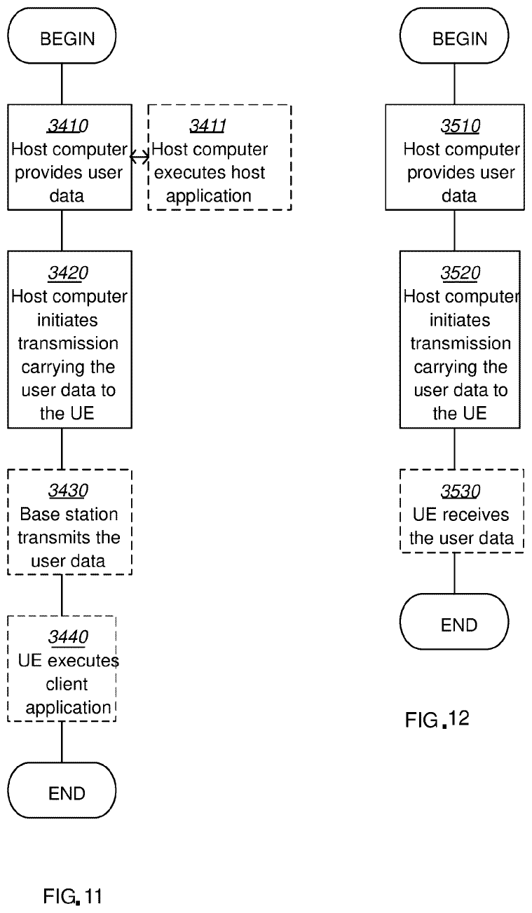

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

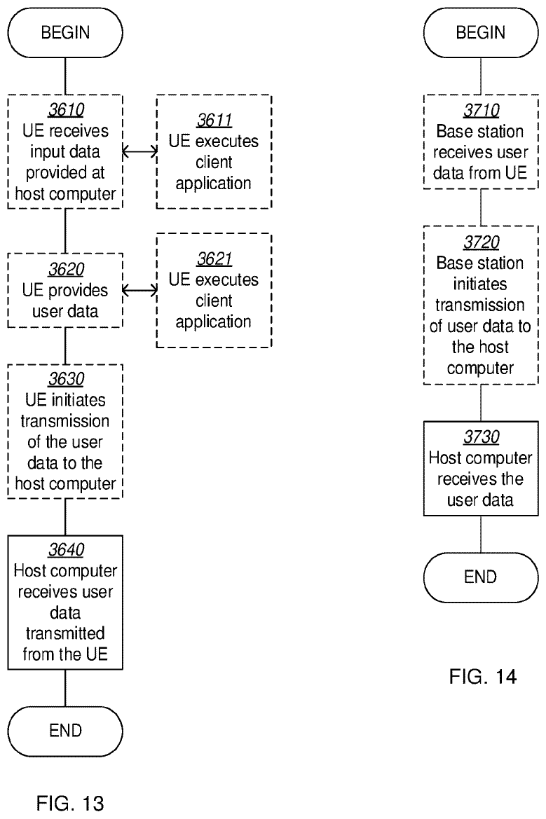

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third step 3630, transmission of the user data to the host computer. In a fourth step 3640 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

### Embodiment 1

A method performed by a network node for handling access of a UE in a communication network, the method comprising:
receiving (301) a request for accessing the network node or a cell related to the network node, wherein the request comprises an indication indicating privileged access; and
determining (302) to accept the request from the UE taking the indication into account.

### Embodiment 2

A method according to embodiment 1, further comprising
reserving a part of UE context system resources for Privileged Access (PA) on a network node, HW, and/or cell level.

### Embodiment 3

A method according to any of the embodiments 1-2, wherein determining to accept the request comprises checking a current load with a first and/or second preemption threshold at the network node.

### Embodiment 4

A method according to any of the embodiments 1-3, wherein determining to accept the request comprises checking a current load with a capability threshold at the network node 12.

### Embodiment 5

A method according to any of the embodiments 3-4, wherein determining to accept the request comprises, in case the current load related to the network node 12 has reached the capability threshold and/or the first and/or second preemption threshold, or is within a range of the capability threshold and/or the first and/or the second preemption threshold, initiating a preemption process related to UE context resources.

### Embodiment 6

A method according to any of the embodiments 1-5, wherein the indication comprises a flag or a value indicating PA.

### Embodiment 7

A method according to any of the embodiments 1-6, further comprising
transmitting a response to the UE 10 indicating acceptance of the request.

### Embodiment 8

A method performed by a UE for handling access of the UE in a communication network, the method comprising:
transmitting (401) to a network node 12, a request for accessing the network node or a cell related to the network node, wherein the request comprises an indication indicating PA; and
receiving (402) from the network node 12, a response accepting the request.

### Embodiment 9

A method according to embodiment 8, wherein the indication comprises a flag or a value indicating PA.

### Embodiment 10

A network node for handling access of a UE in a communication network, the network node is configured to:
receive a request for accessing the network node or a cell related to the network node, wherein the request comprises an indication indicating PA; and
determine to accept the request from the UE taking the indication into account.

### Embodiment 11

A network node according to embodiment 10, wherein the network node is further configured to reserve a part of UE context system resources for PA on a network node, HW, and/or cell level.

### Embodiment 12

A network node according to any of the embodiments 10-11, wherein the network node is configured to determine to accept the request by checking a current load with a first and/or second preemption threshold at the network node.

### Embodiment 13

A network node according to any of the embodiments 10-12, wherein the network node is configured to determine to accept the request by checking a current load with a capability threshold at the network node 12.

### Embodiment 14

A network node according to any of the embodiments 12-13, wherein the network node is configured to determine to accept the request by, in case the current load related to the network node 12 has reached the capability threshold and/or the first and/or second preemption threshold, or is within a range of the capability threshold and/or the first and/or the second preemption threshold, initiating a preemption process related to UE context resources.

### Embodiment 15

A network node according to any of the embodiments 10-14, wherein the indication comprises a flag or a value indicating PA.

### Embodiment 16

A network node according to any of the embodiments 10-15, wherein the network node is configured to
transmit a response to the UE 10 indicating acceptance of the request.

### Embodiment 17

A UE for handling access of the UE in a communication network, wherein the UE is configured to:
transmit to a network node 12, a request for accessing the network node or a cell related to the network node, wherein the request comprises an indication indicating PA; and
receive from the network node 12, a response accepting the request.

### Embodiment 18

A UE according to embodiment 17, wherein the indication comprises a flag or a value indicating PA.

1. A method performed by a network node for handling access of a user equipment, UE, in a communication network, the method comprising:
receiving a request for accessing the network node or a cell related to the network node, wherein the request comprises an indication indicating privileged access, PA, even if at least one of the network node, the cell and the hardware of the network node is congested; and
determining, when at least one of the network node, the cell and the hardware of the network node is congested, to accept the request from the UE taking the indication into account.

2. A method according to claim 1, further comprising
reserving a part of UE context system resources for PA, on at least one of a network node, hardware, and cell level.

3. A method according to claim 1, wherein determining to accept the request comprises checking a current load with at least one of a first and a second preemption threshold at the network node.

4. A method according to claim 1, wherein determining to accept the request further comprises checking a current load with a capability threshold at the network node.

5. A method according to claim 1, wherein determining to accept the request comprises initiating a preemption process related to UE context resources.

6. A method according to claim 1, wherein the indication comprises a flag or a value indicating PA.

7. A method according to claim 1, further comprising
transmitting a response to the UE indicating acceptance of the request.

8. A method performed by a user equipment, UE, for handling access of the UE in a communication network, the method comprising:
transmitting to a network node, a request for accessing the network node or a cell related to the network node, wherein the request comprises an indication indicating privileged access, PA, even if at least one of the network node, the cell and the hardware of the network node is congested; and
receiving from the network node, a response accepting the request.

9. A method according to claim 8, wherein the indication comprises a flag or a value indicating PA.

10. A network node for handling access of a user equipment, UE, in a communication network, wherein the network node is configured to:
receive a request for accessing the network node or a cell related to the network node, wherein the request comprises an indication indicating privileged access, PA, even if at least one of the network node, the cell and the hardware of the network node is congested; and
determine, when at least one of the network node, the cell and the hardware of the network node is congested, to accept the request from the UE taking the indication into account.

11. A network node according to claim 10, wherein the network node is further configured to
reserve a part of UE context system resources for PA on at least one of a network node, hardware, and and/or cell level.

12. A network node according to claim 10, wherein the network node is further configured to determine to accept the request by checking a current load with at least one of a first and a second preemption threshold at the network node.

13. A network node according to claim 10, wherein the network node is further configured to determine to accept the request comprises checking a current load with a capability threshold at the network node.

14. A network node according to claim 10, wherein the network node is further configured to determine to accept the request by initiating a preemption process related to UE context resources.

15. A network node according to claim 10, wherein the indication comprises a flag or a value indicating PA.

16. A network node according to claim 10, wherein the network node is further configured to
transmit a response to the UE indicating acceptance of the request.

17. (canceled)

18. (canceled)

19. (canceled)

20. A computer-readable storage medium, having stored thereon a computer program product comprising instructions which, when executed on at least one processor, cause the at least one processor to carry out the method according to claim 1, as performed by the network node and the UE, respectively.
